(19) United States
(12) Patent Application Publication
(10) Pub. No.: US 2007/0235596 A1
(43) Pub. Date: Oct. 11, 2007

(54) Conduit positioning system, device, and method

(76) Inventor: Douglas A. Youmans, McHenry, IL (US)

Correspondence Address: Charles F. Meroni, Jr., P.O. Box 309, Barrington, IL, 60011, US

(21) Appl. No.: 11/400,501

(22) Filed: Apr. 7, 2006

(51) Int. Cl. F16L 3/22

(52) U.S. Cl. 248/68.1

(57) ABSTRACT

A conduit-positioning device maintains conduit in fixed relation relative to an anchor member. The device comprises a member-attachment interface and a conduit spacer portion. The attachment interface comprises a fastener-receiving bore and the conduit spacer portion comprises at least one conduit-receiving clamp. The fastener-receiving bore extends from an anterior attachment portion to a member-engaging portion. The conduit-receiving clamp positions at least one conduit unit by clamping the conduit unit as the device is anchored to an anchor member by way of the attachment interface.

### BACKGROUND OF THE INVENTION

1. Field of the Invention

The present invention generally relates to a device for securing pipe or conduit to an anchoring stud or similar other structural member. More particularly, the present invention relates to a conduit anchoring device and method for anchoring conduit at an installation site for preventing conduit from becoming otherwise displaced from a desired installation arrangement.

2. Description of the Prior Art

It is necessary to fix conduit in an anchored position at installation sites not only for safety reasons, but also for practical reasons. The conduit, if left unanchored, can become dislodged from primary anchoring arrangements due to play over the length of the conduit and thwart proper installation. Various primary and secondary means for maintaining conduit and piping in fixed anchored spatial locations have been developed and have contributed to the state of the art. Some of the more pertinent patented prior art are listed and briefly described hereinafter.

U.S. Pat. No. 4,705,244 ('244 patent), which issued to Saotome et al., discloses a tube protecting device comprising: a clamp support having first and second end portions and at least one clamp element attached thereto, the first end portion being bent to protrude away from the remainder of the clamp support; tube protecting means having a spring portion, a recess portion and an engageable end portion, the spring portion biasing the first end portion of the clamp support into engagement with the recess, the second end portion of the clamp support engaging the engageable end portion of the tube protecting means.

U.S. Pat. No. 5,184,794 ('794 patent), which issued to Saito, discloses a rod holder includes a pair of clamp members. The clamp members are rotatably hinged at their respective one ends and are lockable as engaged with each other at their respective opposite ends for clamping and retaining a rod member in the rod holder. One of the clamp members is provided at its hinged portion with a stopper for preventing rotation of one of the clamp members beyond a prescribed angle relative to the other clamp member but permitting further rotation of the one clamp member toward the other clamp member upon application of an external force larger than the rotation-preventing force.

U.S. Pat. No. 5,588,683 ('683 patent), which issued to Schliessner, discloses plastics pipe clip comprising at least one article-securing member carried on a support mount adapted to be engaged on a stud projecting from a surface to which the pipe is to be secured having the article-securing member mounted on a flexible bridge member carried by the support mount. The flexible bridge member may straddle the support mount or the support mount may be offset and located at or towards one end of the flexible bridge member. The flexible bridge member may be carried between two rounded, flexing elements attached directly or indirectly to the support mount. A plurality of article-securing members may be mounted on the flexible bridge member and these may be sized to carry pipes and cables of similar diameter or pipes and cables of different diameters.

U.S. Pat. No. 5,954,300 ('300 patent), which issued to Sturies et al., discloses a holding element comprising a base part for arrangement on a carrier, a support member for a component and a damping element is proposed for fastening at least one tubular component on a carrier. The base part and the holding part are connected to one another by at least on flexible web, the damping element being arranged between the base part and the support member. The damping element surrounds the web completely as viewed in the circumferential direction of the web.

U.S. Pat. No. 6,152,406 ('406 patent), which issued to Denndou, discloses a pipe fastener which is capable of holding pipes without requiring a cover, attaching the pipes easily and enhancing a high mounting force of pipes while retaining the vibration absorbing function. The fastener comprises a pipe holder to hold pipes and a panel fixing portion to be fixed to a panel. The pipe holder comprises a pipe engagement portion which receives the pipes inside thereof and engages with them, a damper portion of a vibration absorbing material disposed on the outer portion of the pipe engagement portion, and a holder portion connected to the panel fixing portion to hold the outer portion of the damper portion. The pipe engagement portion, the damper portion and the holder portion are connected with each other as one piece.

U.S. Pat. No. 6,926,237 ('237 patent), which issued to Shereyk et al., discloses an a vibration damping clip of rigid material in which a softer lining is formed on the holding part of the clip including through an aperture in the holding part so that the lining is physically locked thereto. A similar lock is provided at an entrance or lead-in to the substantially annular holding portion of the clip.

It will be seen from an inspection of the foregoing as well as from a general consideration of the state of the art that the prior art does not teach a conduit anchoring strap or clip for preventing displacement of conduit from preferred orientation at an installation site. Thus, the prior art perceives a need for certain secondary conduit anchoring means as may be taught by a conduit anchoring strap or clip for preventing displacement of conduit from preferred orientation at an installation site.

### SUMMARY OF THE INVENTION

It is an object of the present invention to provide a conduit-positioning device for maintaining conduit in fixed relation relative to an anchor member, the conduit-positioning device comprising an anchor or structural member-attachment interface and a conduit-spacer portion extending outwardly from the attachment interface. The structural member-attachment interface comprises an anterior attachment portion, a posterior attachment portion, an anchor or structural member-engaging portion, and a fastener-receiving bore. The conduit-spacer portion comprises an anterior spacer portion, a posterior spacer portion, and at least one conduit-receiving clamp. The fastener-receiving bore extends from the anterior attachment portion to the member-engaging portion.

Each conduit-receiving clamp comprises a clamp axis and is designed to position a conduit unit, each conduit unit having a conduit axis extending therethrough. The member-attachment interface is designed for fixed attachment to an anchor member and the fastener-receiving bore is designed for receiving certain device-to-member or device-member fastening means. When the conduit-receiving clamp or claims receive the conduit unit(s), the conduit axes are held in substantially collinear relation with the clamp axes. The conduit-positioning assembly thus functions to maintain the conduit axes in fixed relation adjacent the anchor member when the device-member fastening means fasten the conduit-positioning assembly to the anchor member by way of the fastener-receiving bore.

The present invention further contemplates a method for anchoring conduit at an installation site, the installation site having a junction box, at least one conduit member, an anchor member, and a loop completion device. The methodology involves certain alignment of structural members and components to enhance the anchored relationship therebetween. In this regard, it is contemplated that the junction box necessarily comprises first and second junction axes and a conduit axis intersection point. The conduit member comprises a box attachment end and a device attachment portion, the device attachment portion comprising a conduit axis. The anchor member comprises an anchor axis. The loop completion device comprises a first spacer axis and at least one, but possibly, a plurality of secondary spacer axes. The first and second junction axes are orthogonal to one another, and the first and second spacer axes are orthogonal to one another.

The method comprises the step of initially attaching the junction box to the anchor member and the box attachment end(s) to the junction box, and the further step of finally fixing the conduit axes relative to a rectangular circuit portion by way of the loop completion device. During the step of initially attaching the junction box to the anchor member and the box attachment end(s) to the junction box, the first and second junction axes and the anchor axis are fixed relative to one another, the first junction axis being orthogonal to the anchor axis, the second junction axis being parallel to the anchor axis, and the conduit axis movably extending through the conduit axis intersection point thus enabling certain conduit movement or certain conduit conic traceability. The first and second junction axes and the anchor axis may thus be described as forming an open, three-sided rectangular circuit portion, closable by the loop completion device.

When the conduit axis or axes are fixed relative to the rectangular circuit portion by way of the loop completion device, the first spacer axis is parallel to the first junction axis and the second spacer axis is collinear with the conduit axis. The loop completion device thus prevents conduit movement or conduit conic traceability, and the conduit member or members are thereby anchored at the installation site.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of my patent drawings, as follows:

FIG. 1 is a plan view of a first alternative conduit-positioning assembly of the present invention showing a preferred spacer device and a first alternative fastener device.

FIG. 2 is a top perspective view of the first alternative conduit-positioning assembly of the present invention showing the preferred spacer device and the first alternative fastener device.

FIG. 3 is a fragmentary perspective view of the first alternative conduit-positioning assembly of the present invention as anchored to a wooden anchor member and thereby positioning three conduit members.

FIG. 4 is a top perspective view of a second alternative conduit-positioning assembly of the present invention showing the preferred spacer device and a second alternative fastener device.

FIG. 5 is a fragmentary perspective view of the second alternative conduit-positioning assembly of the present invention as anchored to a metal anchor member and thereby positioning three conduit members.

FIG. 6 is a front plan view of an installation site of the present invention showing an anchor member, a junction box, a conduit-positioning assembly, and three conduit members.

FIG. 7 is a plan view of a third alternative conduit-positioning assembly of the present invention showing a first alternative spacer device and the first alternative fastener device.

FIG. 8 is a plan view of a fourth alternative conduit-positioning assembly of the present invention showing a second alternative spacer device and the first alternative fastener device.

FIG. 9 is a front plan view of an installation site of the present invention showing an anchor member, a junction box, and a single movably mounted conduit member.

FIG. 10 is a front plan view of an installation site of the present invention showing an anchor member, a junction box, a conduit-positioning assembly, and a single anchored conduit member.

FIG. 11 is a fragmentary perspective view of a junction box with three flexible conduit members attached thereto and anchored to a wooden anchor member.

FIG. 12 is a fragmentary perspective view of the first alternative conduit-positioning assembly of the present invention as anchored to a wooden anchor member and thereby bracing the flexible conduit members shown in FIG. 11.

FIG. 13 is a fragmentary perspective view of a plurality of first alternative conduit-positioning assemblies of the present invention as anchored to a single wooden anchor member thereby bracing the flexible conduit members shown in FIG. 11 in a plurality of vertically spaced locations.

### DETAILED DESCRIPTION OF THE PREFERRED EMBODIMENT(S)

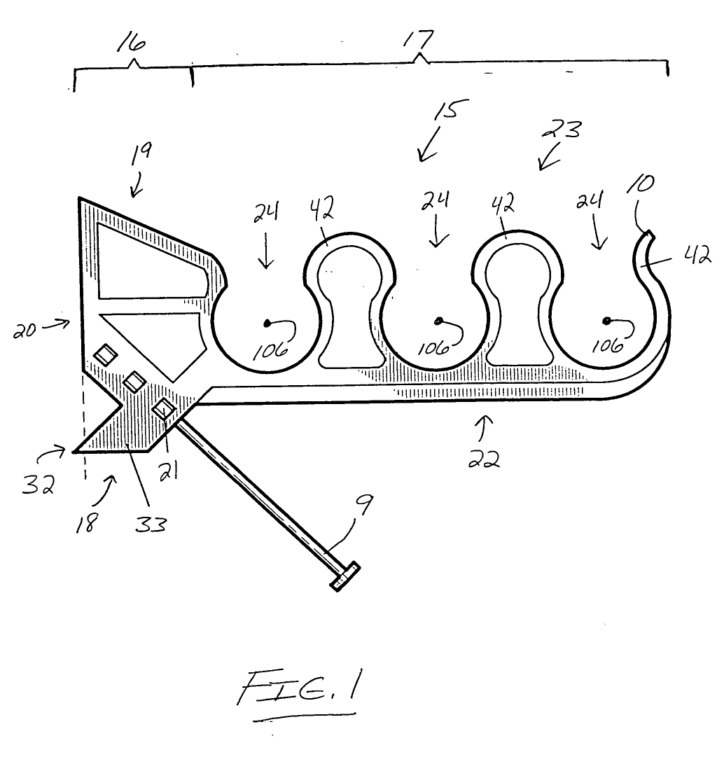

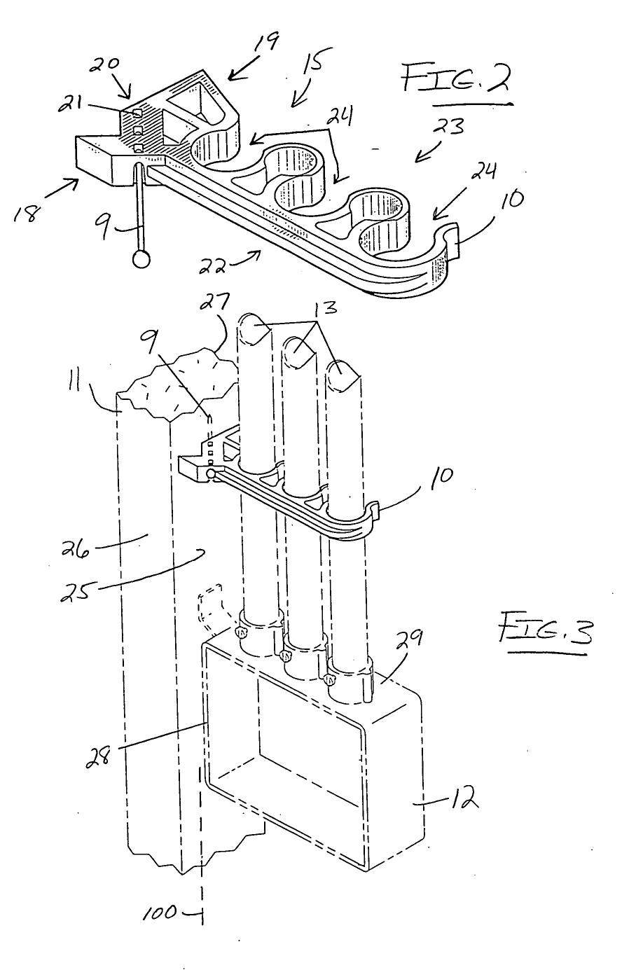

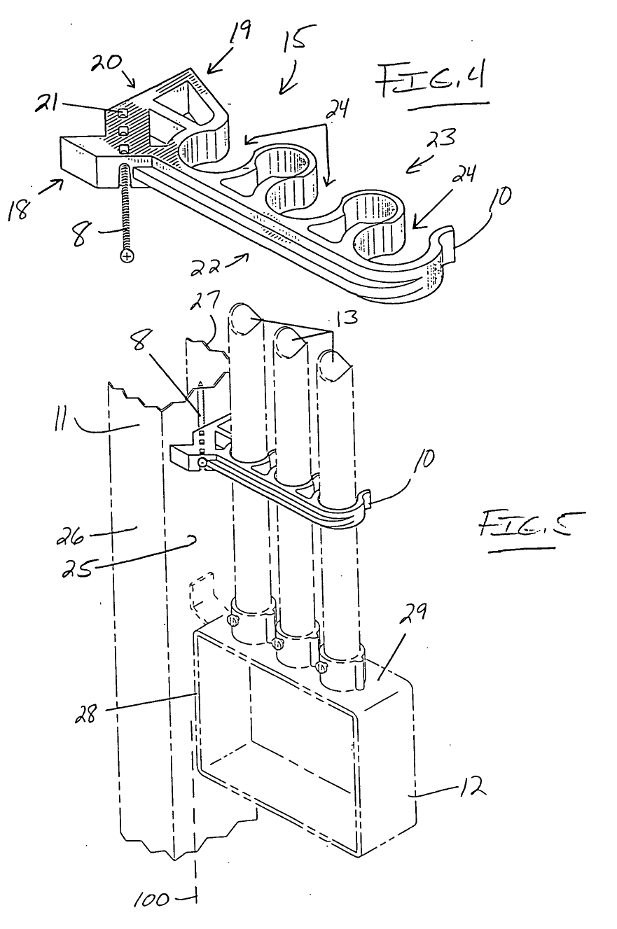

Referring now to the drawings, the preferred embodiment of the present invention concerns a conduit-positioning device for maintaining conduit in fixed relation relative to an anchoring stud 11 or similar other anchor member. Although the present invention further contemplates certain systemic positioning means and certain methodology, central to the practice of the contemplated invention(s) is a conduit-positioning or spacer device 10 as illustrated and referenced in FIGS. 1-6, 10, 12, and 13, which spacer device 10 is anchorable to an anchoring stud 11 as illustrated and referenced in FIGS. 3, 5, 6, and 9-13.

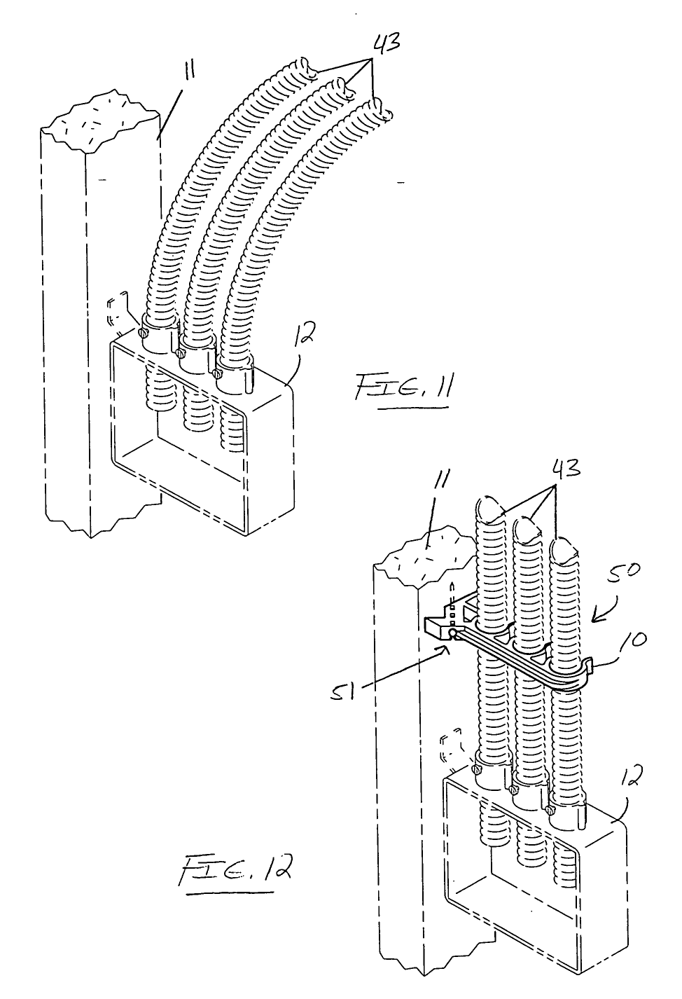

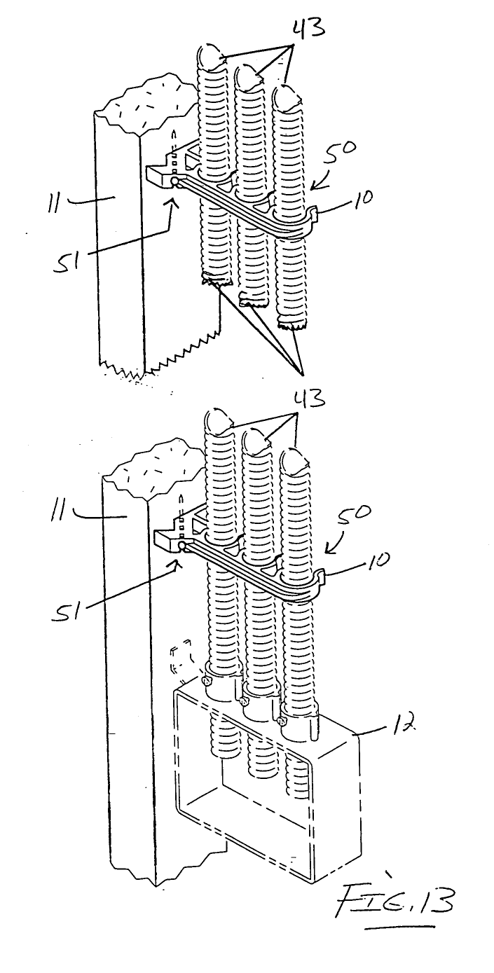

In a systemic sense, the conduit-positioning system of the present invention preferably comprises, in combination a conduit-positioning assembly 15 as illustrated and referenced in FIGS. 1, 2, and 4; anchoring stud 11 as previously noted; a junction box 12 as illustrated and referenced in FIGS. 3, 5, 6, 9-12; and at least one, but, optionally, a plurality of rigid conduit units or conduit members 13 as illustrated and referenced in FIGS. 3, 5, 6, 9, and 10. Certain flexible conduit members 43 are further illustrated in FIGS. 11 and 12. It is contemplated that the spacer device 10 may function to brace or otherwise hold both flexible and rigid conduit to improve safety at (electrical) installation sites.

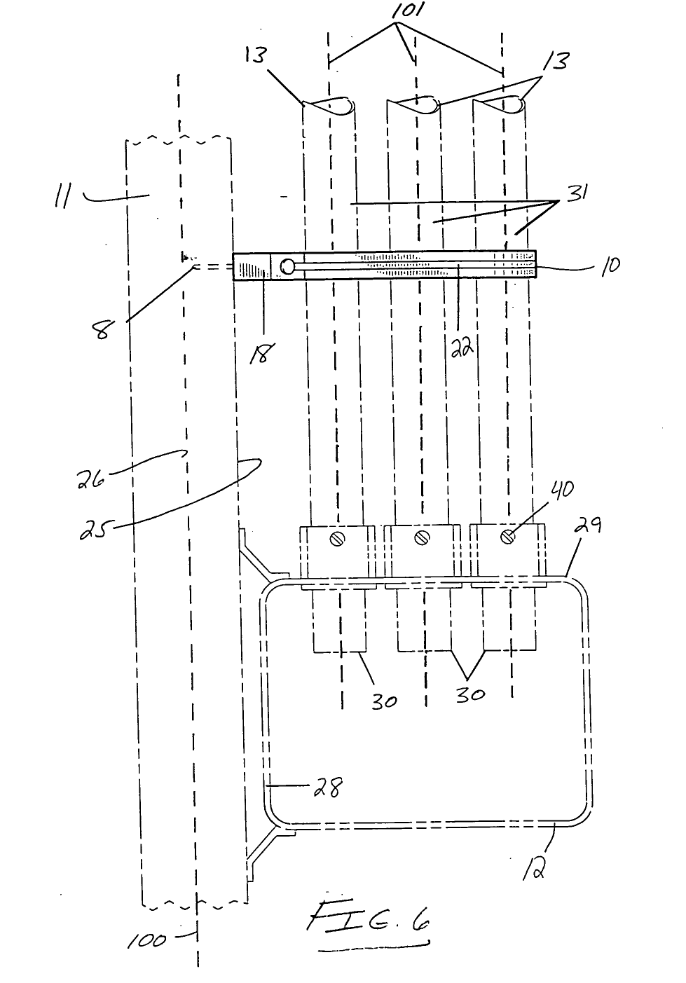

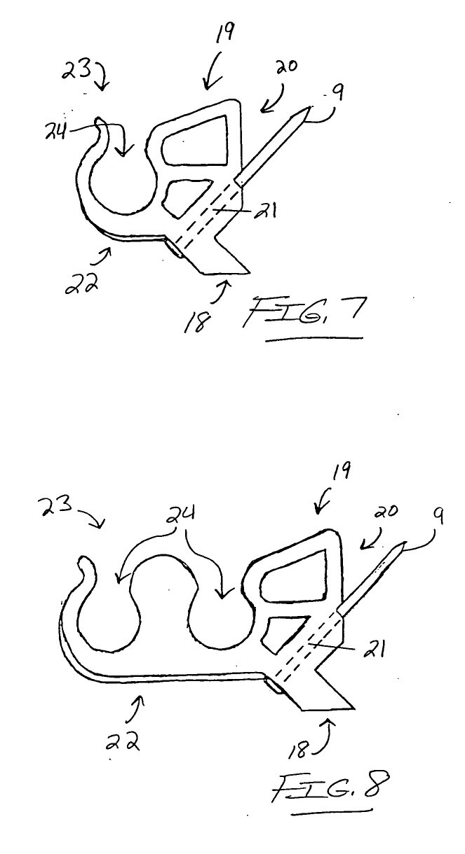

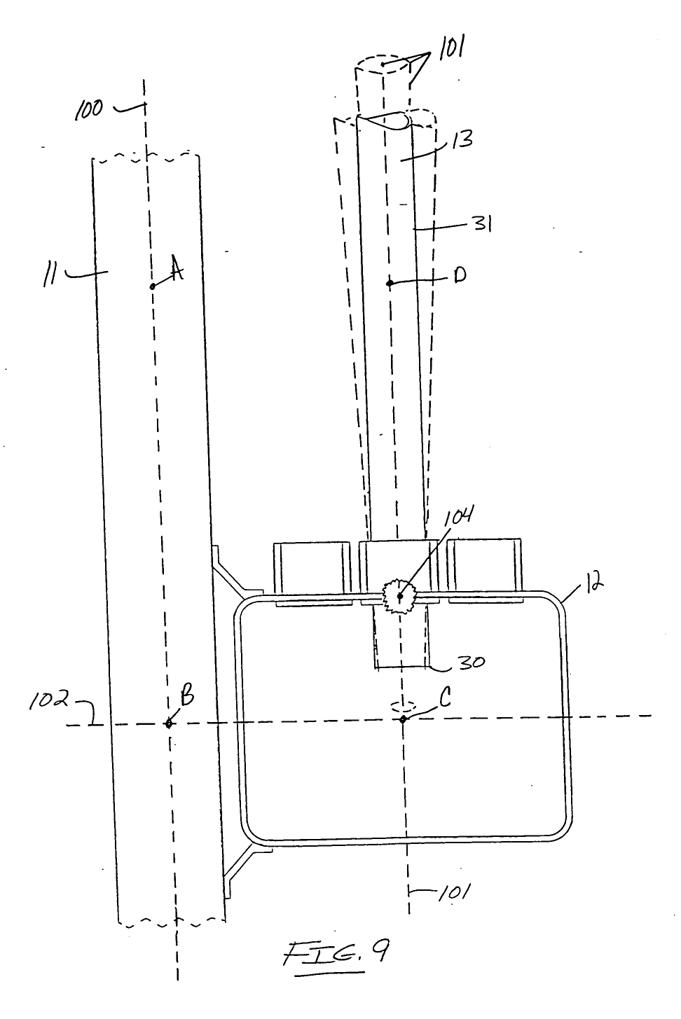

It is contemplated that the conduit-positioning assembly 15 preferably comprises the conduit-positioning or spacer device 10 and certain fastening means as may be preferably defined by a fastener such as a nail 9, self tapping sheet metal screw 8 or similar other piece of fastening hardware. A nail 9 is depicted in FIGS. 1-3, and 6-8. In FIGS. 3 and 6, it will be seen that nail 9 may well function to fasten spacer device 10 to a wooden anchoring stud 11. From an inspection of FIG. 5, it will be seen that a screw 8 may well function to fasten spacer device 10 to a metal anchoring stud 11.

The spacer device 10 is preferably formed from lightweight molded semi-rigid yieldable, high memory plastic material(s) (such as Acrylonitrile Butadiene Styrene (ABS) plastic) and preferably comprises a member or stud-attachment interface 16 and a conduit spacer portion 17 as generally denoted in FIG. 1. The stud-attachment interface 16 preferably comprises an anterior attachment portion 18 as illustrated and referenced in FIGS. 1, 2, 4, and 6-8; a posterior attachment portion 19 as illustrated and referenced in FIGS. 1, 2, 4, 7, and 8; a member or stud-engaging portion or surface 20 as illustrated and referenced in FIGS. 1, 2, 4, 7, and 8; and a fastener-receiving bore 21 as illustrated and referenced in FIGS. 1, 2, 4, 7, and 8.

The conduit-spacer portion 17 or support portion preferably comprises an anterior spacer or anterior stop portion 22 as illustrated and referenced in FIGS. 1, 2, 4, and 6-8; a posterior spacer or gateway portion 23 as illustrated and referenced in FIG. Nos. 1, 2, 4, 7, and 8; and at least one, but, optionally, a plurality conduit-receiving clamp structures or clamps 24 as illustrated and referenced in FIGS. 1, 2, 4, 7 and 9. If more than two conduit-receiving clamps 24 are designed into the structure, as may be seen from an inspection of spacer device 10 depicted in FIGS. 1-5, the conduit-receiving clamps 24 are preferably equally spaced from one another.

The conduit-receiving clamps 24 may be defined in part by certain C-shaped conduit-receiving gates as generally depicted in FIGS. 1, 2, and 4, which conduit-receiving gates are preferably positioned along the posterior spacer portion 23 in side-by-side relation conduit-positioning assembly, the conduit-positioning assembly comprising a series of C-shaped flexible clamps located in side by side spaced relation to one another, the clamps each being flexibly yieldable by way of the yieldable high memory material construction so as to enable the clamps to be freely opened and closed about the conduits to be attached therewith.

It will be understood from a consideration of FIGS. 1-3, for example, that the conduit-positioning assembly comprises a series of generally C-shaped flexible clamps 24 positioned on the support or spacer portion 17 and located in side by side spaced relation relative to one another. Each of the clamps 24 have flexibly yieldable or yielding clamp legs as referenced at 42 in FIG. 1, which legs 42 are freely opened and closed about the conduit members 13 or 43 as the members 13 or 43 are pushed into engagement with, or snap fit into, clamps 24 to be held therewith. Thus, the clamps 24 and/or gates are preferably sized and shaped to snap fit (by way of the semi-rigid preferred construction materials) to ½ inch electrical metallic tubing (EMT) and line up exactly the same measurement from the stud as the EMT conduits would be if they were installed into an industry standard ubiquitous 1900 electrical box as generally depicted in FIGS. 3, 5, 6, and 9-13.

It will be seen from an inspection of the noted figures that the fastener-receiving bore 21 is substantially linear and extends from the anterior attachment portion 18 to the stud attachment portion 20. The fastener-receiving bore 21 inherently comprises a fastener entry aperture and a fastener exit aperture. The opposite apertures are specifically located to enhance receipt or engagement of the fastening means and in this regard, it will be seen that the fastener entry aperture is preferably located adjacent the anterior spacer portion 22 and that the fastener exit aperture is preferably located equidistant intermediate the anterior attachment portion 18 and the posterior attachment portion 19 thus providing an angled fastener-receiving bore 21 for enabling a user to more effectively drive the fastener for affixing the stud attachment portion 20 to the anchoring stud 11. It is contemplated that the angled fastener-receiving bore 21 may preferably be angled approximately 45 degrees from the stud attachment portion 20 for maximizing the user's ability to effectively drive the fastener intermediate the anterior spacer portion 22 and the anterior attachment portion 18 for affixing the stud attachment interface 16 to the anchoring stud 11.

The stud-engaging portion 20 at the anterior attachment portion 18 is preferably offset relative to the stud-engaging portion 20 at the posterior portion 19 as generally depicted at 32 in FIG. 1. It is contemplated that this feature may well function to enhance fixed attachment to the anchoring surface when the fastener is driven into the anchoring stud 11. Preferably, the stud-engaging portion 20 at the anterior attachment portion 18 is defined by an anchoring projection 33, which anchoring projection 33 has a projection axis 34 substantially orthogonal to the fastener-receiving bore 21 for enhancing fixed attachment to the anchoring stud 11 when the fastener is driven therein. In other words, it is contemplated that when the fastener engages the anchoring stud 11 and anchors stud-engaging portion thereagainst, anchoring projection 33 may function to either embed the tip or offset thereof into a wooden anchoring stud 11 or to deflect and fixedly wedge anchoring projection 33 to a metallic anchoring stud 11.

It is contemplated that the anchoring stud or anchor member 11 may preferably be constructed from wood such as hewn lumber (as generally depicted in FIG. 3) or metal (as generally depicted in FIG. 5) and may be defined by a weight-bearing or wall-forming type stud as found in typical construction applications. The anchoring stud or anchor member 11 preferably comprises an anchoring surface 25 as referenced in FIGS. 3, 5, and 6; an anterior stud portion 26 as referenced in FIGS. 3, 5, and 6; a posterior stud portion 27 as referenced in FIGS. 3 and 5; and a longitudinal stud or anchor axis 100 as referenced in FIGS. 3, 5, 6, 9, and 10. The anterior stud portion 26 extends in a first stud plane and the posterior stud portion 27 extends in a second stud plane, which first and second member or stud planes are substantially parallel stud planes. It will be further understood from a consideration of the FIGS. 3, 5, and 6 that the junction box 12 comprises a stud-attachment portion 28 and a conduit attachment portion 29, and the stud-attachment portion 28 is affixed or anchored to the anchoring surface 25 via any suitable state of the art anchoring means intermediate the parallel stud planes.

The conduit members or conduit units 13 each comprise a box attachment end 30 and a device attachment portion 31 as generally denoted in FIGS. 6, 9, and 10. It will be seen from an inspection of FIG. 6 that the device attachment portions 31 each have a conduit axis 101 extending therethrough and that the conduit units 13 are each affixed to the conduit attachment portion 29 by way of the box attachment ends 30.

It is noted that box attachment ends 30 may be primarily anchored by way of their attachment to junction box 12. The primary anchoring arrangement, however, is typically insufficient to prevent movement of the device attachment portions 31 as portions 31 are spatially separated from the box attachment ends 30 and thus some secondary anchoring arrangement is desirous at portions 31.

When primarily anchored by way of set screw assemblies and the like as at 40 in FIG. 6, the conduit units 13 are arranged in adjacency to the anchoring surface 25. The stud-attachment interface 16 is preferably affixed to the anchoring surface 25 at a select distance from the junction box 12 by way of the fastener as driven through the fastener-receiving bore 21 into the anchoring surface 25. The conduit-receiving clamps 24 receive and clamp the conduit units 13 and the conduit-positioning assembly 15 thereby holds the conduit axes 101 in substantially parallel relation to the stud axis 100 adjacent the anchoring stud 11. The conduit-positioning system or device thus functions to maintain the conduit units 13 in fixed relation relative to the anchoring stud 11.

It will be recalled that the conduit-receiving clamps 24 may be defined in part by certain conduit-receiving gates as generally depicted in FIGS. 1, 2, and 4, which conduit-receiving gates are preferably positioned along the posterior spacer portion 23. The conduit-receiving gates are preferably positioned along the posterior spacer portion 23 so that when the conduit units 13 are received by the conduit-receiving clamps 24 by way of the conduit-receiving gates, anterior displacement (accidental or otherwise) of the conduit units 13 may be prevented. In this regard, it is noted that electrical installations of the type partially illustrated in FIGS. 3, 5, and 6 are typically configured in spaces having a rearwardly located stop structure (such as a wall) and that forward movement of conduit members may otherwise occur after connecting box attachment ends 30 to a junction box. Thus, the spacer device 10, when attached to conduit units 13 may well function to not only maintain parallel alignment of the conduit axes 101, but also prevent anterior displacement thereof.

In keeping with the foregoing notion(s), it is contemplated that spacer device 10 functions to maintain the conduit axes 101 in substantially coplanar relation. It will be recalled that the anterior and posterior stud portions 26 and 27 extend in substantially parallel stud planes. The spacer device 10 comprises a certain spacer depth extending intermediate the anterior attachment portion 18 and the posterior attachment portion 19, and a certain stud depth extends intermediate the anterior stud portion 26 and the posterior stud portion 27. Preferably, the spacer depth is lesser in magnitude than the stud depth. Thus, the spacer device 10 functions to prevent the intersection of the conduit axes 101 with the stud planes.

As earlier summarized, the present invention further contemplates certain methodology for anchoring conduit at an installation site, which installation site may be a typical electrical installation site, and which installation site necessarily comprises a junction box (such as junction box 12), at least one conduit member (such as a conduit member 13), an anchor member (such as anchor member 11), and a loop completion device (such as spacer device 10). The methodology involves certain cooperative alignment of structural members and components to enhance the anchored relationship therebetween.

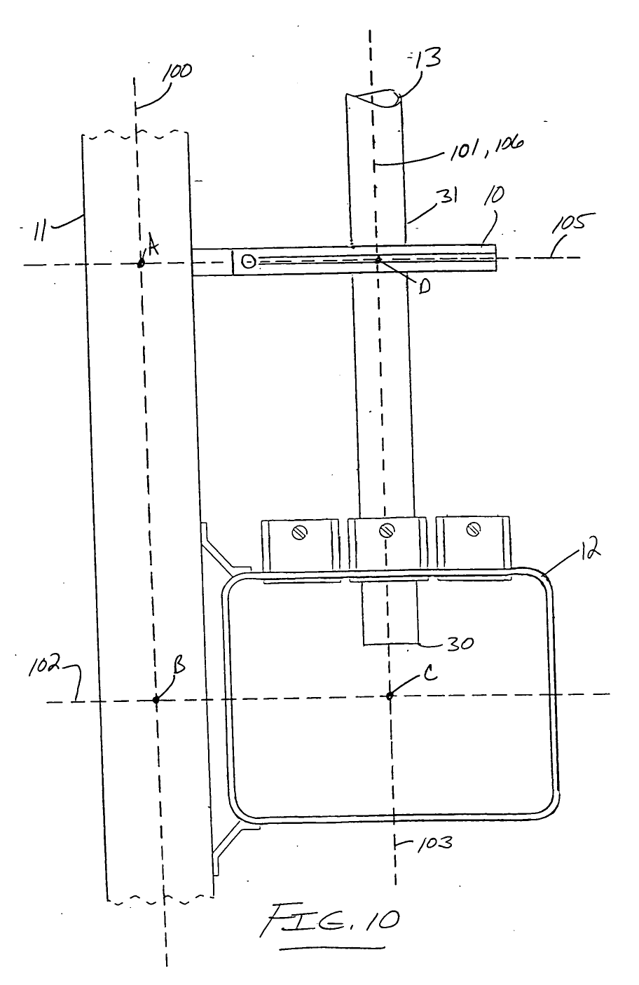

In this regard, it is contemplated that the junction box necessarily comprises a first junction axis 102 as denoted in FIGS. 9 and 10; a second junction axis 103 as denoted in FIGS. 9 and 10; and a conduit axis intersection point 104 as denoted in FIG. 9. The conduit member 13 comprises a box attachment end 30 and a device attachment portion 31, the device attachment portion 31 comprising a conduit axis 101. The anchor member comprises a stud or anchor axis 100. The spacer device 10 or loop completion device comprises a first spacer axis 105 as denoted in FIG. 10, and at least one, but possibly, a plurality of secondary spacer axes 106 as denoted at points 106 in FIG. 1 (the axes 106 extending into/out of the page). It will be seen from an inspection of the noted figures that the first and second junction axes 102 and 103 are orthogonal to one another. It may be further readily understood from a comparative inspection of FIG. 1 versus FIGS. 9 and 10 that the first and second spacer axes 105 and 106 are also orthogonal to one another.

The method essentially comprises the step of initially attaching the junction box 12 to the anchor member 11 and the box attachment end(s) 30 to the junction box 12. It is noted that junction boxes 12 are typically attached first before attaching box attachment ends 30 to the junction box 12, and thus the listing of components has been represented in this specification in this manner. However, it is contemplated that the initial step of attaching is not necessarily limited to (1) box-to-stud attachment and (2) conduit-to-box attachment in this order, but may also include (1) conduit-to-box and (2) box-to-stud attachment processes. The central notion being addressed is the fixation of axes relative to one another in a methodical manner.

In this last regard, it should be noted that during the step of initially attaching the junction box 12 to the anchor member 11 and the box attachment end(s) 30 to the junction box 12, the first and second junction axes 102 and 103 and the anchor axis 100 are fixed relative to one another such that the first junction axis 102 is orthogonal to the anchor axis 100, the second junction axis 103 is parallel to the anchor axis 100, and the conduit axis 101 movably extends through the conduit axis intersection point 104 thus enabling certain conduit movement or certain conduit conic traceability as generally depicted in FIG. 9.

From a careful inspection of FIG. 9 and from a consideration of geometric principles, it will be understood that an axis extending through a vertex (such as axis intersection point 14) may be movable thereabout and may thus trace certain conical sections. Thus, the conduit axis 101 movably extends through axis intersection point 104 and may enable certain undesirable conduit conic traceability. It will be further seen from an inspection of FIG. 9 that the first and second junction axes 102 and 103 and the anchor axis 100 may be further described as forming an open, three-sided rectangular circuit portion as denoted by sections AB, BC, and CD in FIGS. 9 (and 10), which open, three-sided rectangular circuit portion is closable by the loop completion device as at section AD in FIG. 10.

In this last regard, it should be noted that when the conduit axis 103 or axes 103 are fixed relative to the three-sided rectangular circuit portion by way of the loop completion device, the first spacer axis 105 is parallel to the first junction axis 102 and the second spacer axis 106 or axes 106 is/are collinear with the conduit axis 101 or axes 101 to form a clamp-conduit or conduit-clamp axis or axes. The loop completion device or spacer device 10 thus functions to prevent undesirable conduit movement or conduit conic traceability, and the conduit member 13 or members 13 are thereby anchored at the installation site.

Should the installation site require a plurality of conduit members 13, it is contemplated that the junction box comprises a plurality of conduit axis intersection points 104, and the loop completion device will comprise a plurality of second(ary) spacer axes 106. The movably extending conduit axes 101 extend through the conduit axis intersection points 104 thus enabling certain plural conduit conic traceability. The methodology then contemplates that the conduit axes 101 may be simultaneously fixed relative to the rectangular circuit portion by way of the loop completion device. The second spacer axes 101 are thus respectively collinear with the conduit axes 101 to form a plurality of clamp-conduit axes. The conduit axes 101 may be preferably fixed in co linearity with the spacer axes 106 before the conduit axes 101 are simultaneously fixed relative to the three-sided rectangular circuit portion. In other words, it is preferable to attach the loop completion device to the conduit members 13 before anchoring the loop completion device to anchor member 11.

The loop forming device is installed by manually snapping it on to the conduits with finger-provided forces. Once snapped into place the loop forming device, the device snugly positions the conduit. If the installation technician were to remove his or her hands from the device after snapping the same into conduit-positioning assembly, the interface 16 would be floating about ⅛ inch away from the anchoring member. To anchor the device to the anchoring member, the installer closes the ⅛ inch gap and the nail 9 or screw 8 is driven into the anchoring member. According to the National Electrical Code Article 358.30(A), each EMT run between termination points shall be securely fastened within 900 mm (about 3 feet) of each outlet box, cabinet, conduit body, or other tubing termination, and thus it is contemplated that the length of sections AD and CD should fall within these parameters.

While the above description contains much specificity, this specificity should not be construed as limitations on the scope of the invention, but rather as an exemplification of the invention. For example, as is described hereinabove, it is contemplated that the present invention essentially discloses a conduit-positioning device for maintaining conduit in fixed relation relative to an anchor member. The conduit-positioning device comprises a member-attachment interface (such as interface 16) and a conduit-spacer portion. The member-attachment interface comprises an anterior attachment portion, a posterior attachment portion, a member-engaging portion, and a fastener-receiving bore. The conduit-spacer portion comprises an anterior spacer portion, a posterior spacer portion, and at least one conduit-receiving clamp.

The fastener-receiving bore extends from the anterior attachment portion to the member-engaging portion. Each conduit-receiving clamp comprises a clamp axis and is designed to position a conduit unit or member, each of which has a conduit axis extending therethrough. The member-attachment interface is designed for fixed attachment to an anchor member, and the fastener-receiving bore is designed to receive certain device-to-member fastening means. The conduit axis is collinear with the clamp axis when the conduit-receiving clamp clampedly receives or clamps the conduit unit. Thus, the conduit-positioning assembly may well function to maintain the conduit axis in fixed relation adjacent the anchor member when the device-member fastening means fasten the conduit-positioning assembly to the anchor member by way of the fastener-receiving bore.

Furthermore, the invention contemplates a certain method for bracing conduit in an electrical installation, the method comprising the steps of: attaching an electrical conduit box (such as junction box 12) to an upright frame having spaced studs (as may be defined by anchoring member or stud 11); selecting one or more flexible conduits (such as conduit member(s) 43) to be attached to the electrical conduit box; connecting a selected flexible conduit at one end (such as box attachment end 30) to the electrical conduit box leaving an opposite end of the flexible conduit loose and hanging free and bent over from its secured end; attaching a brace member (such as spacer device 10) to the loose conduit at a point vertically spaced from the electrical conduit box as depicted at reference numeral 50 in FIGS. 12 and 13; and fastening an end of the brace member to a stud located in closest proximity to hold a portion of the conduit (such as device attachment portion 31) between the electrical conduit box and the brace member in a secured upright position parallel to the stud as depicted at 51 in FIGS. 12 and 13.

The method may further involve the step(s) of attaching an additional brace member or members at vertically spaced locations along the length of the loose conduit at points vertically spaced above the electrical conduit box by fastening each brace member at one end thereof to the stud located in closest proximity to hold successive portions of the conduit in a secured upright position parallel to the stud. FIG. 13 generally depicts an installation site with certain parts of stud 11 and conduit members 43 broken away to show a plurality of spacer member 10 attached at vertically spaced locations along the length of otherwise loose conduit in superior adjacency to the junction box 12, each of which spacer devices 10 is fastened at one end thereof to the anchoring stud 11 in similarly spaced vertical locations.

Accordingly, although the invention has been described by reference to certain preferred embodiments and methodology, it is not intended that the novel disclosures herein presented be limited thereby, but that modifications thereof are intended to be included as falling within the broad scope and spirit of the foregoing disclosure, the following claims and the appended drawings.

I claim:

1. A conduit-positioning system for maintaining conduit in fixed relation relative to an anchoring stud, the conduit-positioning system comprising, in combination:
a conduit-positioning assembly, the conduit-positioning assembly comprising a spacer device and a fastener, the spacer device comprising a stud-attachment interface and a conduit-spacer portion, the stud-attachment interface comprising an anterior attachment portion, a posterior attachment portion, a stud-engaging portion, and a fastener-receiving bore, the conduit-spacer portion comprising an anterior spacer portion, a posterior spacer portion, and at least one conduit-receiving clamp, the fastener-receiving bore extending from the anterior attachment portion to the stud-engaging portion;
an anchoring stud, the anchoring stud comprising an anchoring surface, an anterior stud portion, a posterior stud portion, and a longitudinal stud axis;
a junction box, the junction box comprising an stud-attachment portion and a conduit attachment portion, the stud-attachment portion being affixed to the anchoring surface; and
at least one conduit unit, each conduit unit comprising a box attachment end and a device attachment portion, each device attachment portion having a conduit axis extending therethrough, each conduit unit being affixed to the conduit attachment portion by way of the box attachment end, each conduit unit thus being arranged in adjacency to the anchoring surface, the conduit-receiving clamp clamping the conduit unit, the stud-attachment interface being affixed to the anchoring surface at a select distance from the junction box by way of the fastener as driven through the fastener-receiving bore into the anchoring surface, the conduit-positioning assembly holding each conduit axis in substantially parallel relation to the stud axis, the conduit-positioning system thus maintaining conduit in fixed relation relative to the anchoring stud.

2. The conduit-positioning system of claim 1 wherein each conduit-receiving clamp comprises a conduit-receiving gate formed along the posterior spacer portion, the posterior spacer portion thus forming a gateway portion, the gateway portion for receiving conduit and preventing anterior displacement thereof.

3. The conduit-positioning system of claim 1 wherein the fastener-receiving bore comprises a fastener entry aperture and a fastener exit aperture, the fastener entry aperture being located adjacent the anterior spacer portion, the fastener exit aperture being located equidistant intermediate the anterior and posterior attachment portions for providing an angled fastener-receiving bore, the angled fastener-receiving bore for enabling a user to effectively drive the fastener for affixing the stud attachment interface to the anchoring surface.

4. The conduit-positioning system of claim 3 wherein the angled fastener-receiving bore is angled approximately 45 degrees from the stud-engaging portion for maximizing the user's ability to effectively drive the fastener intermediate the anterior spacer portion and the anterior stud portion for affixing the stud-attachment interface to the anchoring surface.

5. The conduit-positioning system of claim 1 wherein the anterior and posterior stud portions extend in substantially parallel stud planes, a spacer depth extends intermediate the anterior attachment portion and the posterior attachment portion, and a stud depth extends intermediate the anterior stud portion and the posterior stud portion, the spacer depth being lesser in magnitude than the stud depth, the spacer device being-affixed for preventing the intersection of each conduit axis with the stud planes.

6. The conduit-positioning system of claim 1 wherein the stud-engaging portion at the anterior attachment portion is offset relative to the stud-engaging portion at the posterior portion, the offset stud-engaging portion for enhancing fixed attachment to the anchoring surface when the fastener is driven into the anchoring surface.

7. The conduit-positioning system of claim 6 wherein the offset stud-engaging portion is defined by an anchoring projection, the anchoring projection having a projection axis, the projection axis being substantially orthogonal to the fastener-receiving bore for enhancing fixed attachment to the anchoring surface when the fastener is driven into the anchoring surface.

8. A conduit-positioning device for maintaining conduit in fixed relation relative to an anchor member, the conduit-positioning device comprising a member-attachment interface and a conduit spacer portion, the member-attachment interface comprising an anterior attachment portion, a posterior attachment portion, a member-engaging portion, and a fastener-receiving bore, the conduit spacer portion comprising an anterior spacer portion, a posterior spacer portion, and at least one conduit-receiving clamp, the fastener-receiving bore extending from the anterior attachment portion to the member-engaging portion, each conduit-receiving clamp comprising a clamp axis, the conduit-receiving clamp for positioning at least one conduit unit, each conduit unit having a conduit axis extending therethrough, the member-attachment interface for fixed attachment to an anchor member, the fastener-receiving bore for receiving fastening means, the conduit axis being collinear with a respective clamp axis when the conduit unit is clamped thus forming at least one conduit-clamp axis, the conduit-positioning assembly for maintaining the conduit axis in fixed relation adjacent the anchor member when the fastening means fasten the conduit-positioning assembly to the anchor member by way of the fastener-receiving bore.

9. The conduit-positioning assembly of claim 8 wherein the conduit spacer portion comprises a plurality of conduit-receiving clamps, the clamp axes being substantially coplanar, the conduit-receiving clamps for positioning a plurality of conduit units, the conduit-positioning assembly thus for maintaining the conduit axes in fixed, substantially coplanar relation adjacent the anchor member.

10. The conduit-positioning assembly of claim 9 wherein the conduit-receiving clamps comprise transverse conduit-receiving gates, the conduit-receiving gates being aligned along the posterior spacer portion, the conduit units being receivable by the conduit-receiving clamps by way of the conduit-receiving gates for preventing anterior displacement of the conduit units.

11. The conduit-positioning assembly of claim 8 wherein the fastener-receiving bore comprises a fastener entry aperture and a fastener exit aperture, the fastener entry aperture being located adjacent the anterior spacer portion, the fastener exit aperture being located equidistant intermediate the anterior and posterior attachment portions thus providing an angled fastener-receiving bore, the angled fastener-receiving bore for maximizing a user's ability to fasten the member-engaging portion to the anchor member.

12. The conduit-positioning assembly of claim 9 wherein the conduit-clamp axes are parallel to one another, the anchor member comprises anterior and posterior member portions extending in substantially parallel member planes, a spacer depth extends intermediate the anterior attachment portion and the posterior attachment portion, and a member depth extends intermediate the anterior member portion and the posterior member portion, the spacer depth being lesser in magnitude than the member depth, the conduit-positioning assembly being anchorable to the anchor member for preventing the intersection of the conduit-clamp axes with the member planes.

13. The conduit-positioning assembly of claim 8 wherein the member-engaging portion at the anterior attachment portion is offset from the member-engaging portion at the posterior portion, the offset member-engaging portion for enhancing fixed attachment to the anchor member when the fastening means fasten the conduit-positioning assembly to the anchor member.

14. The conduit-positioning assembly of claim 13 wherein the offset member-engaging portion is defined by an anchoring projection, the anchoring projection having a projection axis, the projection axis being substantially orthogonal to the fastener-receiving bore for enhancing fixed attachment to the anchor member.

15. A conduit-positioning device for maintaining a series of conduits in fixed side-by-side relation relative to an anchoring stud, the conduit-positioning device comprising, in combination:
a conduit-positioning assembly, the conduit-positioning assembly comprising a series of generally C-shaped flexible clamps positioned on a support portion and located in side by side spaced relation to one another, each of the clamps having flexibly yieldable clamp legs which legs are freely opened and closed about the conduits to be held therewith, the conduits each having a box attachment end and a device attachment portion, each device attachment portion having a conduit axis extending therethrough, the conduits being affixed to a junction box by way of the box attachment ends, the junction box being attached to an anchoring stud, the conduits thus being arranged in adjacency to the anchoring stud, the clamps providing means to hold the conduits in an upright position, the conduit-positioning assembly being affixed to the anchoring stud at a select distance from the junction box by way of fastening means, the conduit-positioning assembly holding each conduit axis in substantially parallel relation to the anchoring stud, the conduit-positioning device thus maintaining conduit in upright parallel relation relative to the anchoring stud.

16. A method for anchoring conduit at an installation site, the installation site having a junction box, at least one conduit member, an anchor member, and a loop completion device, the junction box comprising first and second junction axes and a conduit axis intersection point, the conduit member comprising a box attachment end and a device attachment portion, the device attachment portion comprising a conduit axis, the anchor member comprising an anchor axis, the loop completion device comprising a first spacer axis and at least one second spacer axis, the first and second junction axes being orthogonal to one another, the first and second spacer axes being orthogonal to one another, the method comprising the steps of:
attaching the junction box to the anchor member and the box attachment end to the junction box, the first and second junction axes and the anchor axis being fixed relative to one another, the first junction axis being orthogonal to the anchor axis, the second junction axis being parallel to the anchor axis, the conduit axis movably extending through the conduit axis intersection point thus enabling conduit conic traceability, the first and second junction axes and the anchor axis forming an open, three-sided rectangular circuit portion; and
fixing the conduit axis relative to the rectangular circuit portion by way of the loop completion device, the first spacer axis being parallel to the first junction axis, the second spacer axis being collinear with the conduit axis, the loop completion device for preventing conduit conic traceability, the conduit member thereby being anchored at the installation site.

17. The method of claim 15 wherein the installation site comprises a plurality of conduit members, the junction box comprises a plurality of conduit axis intersection points, and the loop completion device comprises a plurality of second spacer axes, the conduit axes movably extending through the conduit axis intersection points thus enabling plural conduit conic traceability, the conduit axes being simultaneously fixed relative to the three-sided rectangular circuit portion by way of the loop completion device, the second spacer axes being respectively collinear with the conduit axes, the loop completion device for preventing plural conduit conic traceability, the conduit members thereby being simultaneously anchored at the installation site.

18. The method of claim 16 wherein the conduit axes are fixed in co linearity with the second spacer axes before the conduit axes are simultaneously fixed relative to the three-sided rectangular circuit portion.

19. The method of claim 16 wherein the loop completion device comprises an anterior stop portion and a posterior gateway portion, the conduit axes being simultaneously fixed relative to the three-sided rectangular circuit portion by way of the posterior gateway portion, the anterior stop portion for preventing anterior displacement of the conduit axes.

20. The method of claim 18 wherein the conduit axes are fixed relative to the three-sided rectangular circuit portion by way of the loop completion device and fastening means, the fastening means fastening the loop completion device to the anchor member by way of a fastener-receiving bore, the fastener-receiving bore extending from the anterior stop portion to a fastener exit aperture, the fastener exit aperture being located equidistant intermediate the anterior stop portion and the posterior gateway portion for enhancing attachment to the anchor member.

21. The method of claim 19 wherein the loop completion device comprises an anchoring projection, the anchoring projection having a projection axis, the projection axis being substantially orthogonal to the fastener-receiving bore, the anchoring projection for enhancing attachment to the anchor member.

22. A method for bracing conduit in an electrical installation, the method comprising the steps of:
attaching an electrical conduit box to an upright frame having horizontally spaced studs;
selecting one or more flexible conduits to be attached to the electrical conduit box;
connecting a selected flexible conduit at one end to the electrical conduit box leaving an opposite end of the flexible conduit loose and hanging free and bent over from its secured end;
attaching a brace member to the loose conduit at a point vertically spaced from the electrical conduit box; and
fastening an end of the brace member to a stud located in closest proximity to hold a portion of the conduit between the electrical conduit box and the brace member in a secured upright position parallel to the stud.

23. The method of claim 22 attaching additional brace members at vertically spaced locations along the length of the loose conduit at points vertically spaced above the electrical conduit box by fastening each brace member at one end thereof to the stud located-in closest proximity to hold successive portions of the conduit in a secured upright position parallel to the stud.
